(19) United States
(12) Patent Application Publication
(10) Pub. No.: US 2011/0159364 A1
(43) Pub. Date: Jun. 30, 2011

(54) NONAQUEOUS ELECTROLYTE SECONDARY BATTERY AND ELECTRODE FOR NONAQUEOUS ELECTROLYTE SECONDARY BATTERY

(76) Inventors: Shumpei NISHINAKA, Osaka-shi (JP); Naoto Nishimura, Osaka-shi (JP)

(21) Appl. No.: 12/978,773

(22) Filed: Dec. 27, 2010

(30) Foreign Application Priority Data
Dec. 28, 2009 (JP) 2009-298113

(51) Int. Cl. H01M 4/62

(52) U.S. Cl. 429/217

(57) ABSTRACT

A nonaqueous electrolyte secondary battery has an electrode composed of a positive and negative electrodes containing an active material, and a separator between the positive electrode and the negative electrode; wherein one of the positive electrode and the negative electrode contains a binder and is formed on a current collector; the current collector has a structure composed of a resin layer so as to melt upon an abnormal heat generation and a metal layer as an electric conductor formed on both sides of the resin layer; the resin layer has a melting point of 120 to 250° C.; and the binder has a melting point between 70° C. and a lower temperature than above mentioned melting point of the resin layer by 40° C.

### CROSS-REFERENCE TO RELATED APPLICATION

This application is related to Japanese application No. 2009-298113 filed on Dec. 28, 2009, whose priority is claimed under 35 USC §119, the disclosure of which is incorporated by reference in its entirety.

### BACKGROUND OF THE INVENTION

1. Field of the Invention

The present invention relates to a nonaqueous electrolyte secondary battery and an electrode for the nonaqueous electrolyte secondary battery. More specifically, the present invention relates to a nonaqueous electrolyte secondary battery with an improved safety upon an abnormal heat generation and an electrode for the nonaqueous electrolyte secondary battery.

2. Description of the Related Art

Nonaqueous electrolyte secondary batteries typified by a lithium-ion secondary battery (hereinafter referred to also as secondary batteries) have been widely utilized for consumer products since they have a high capacity and a high energy density and are excellent in storage performance and cycling characteristics of charge and discharge. On the other hand, sufficient measures for a safety are required since lithium and a nonaqueous electrolyte are used in the secondary battery.

For example, in the secondary battery having a large capacity and a high energy density, an excessive short circuit current flows in the case where a short circuit occurs by some cause between a positive electrode and a negative electrode of the secondary battery. The short circuit current generates Joule heat by an internal resistance to raise a temperature of the secondary battery. Thus, a function of preventing the secondary battery from falling into an abnormal heat generation state is provided in the secondary battery using a nonaqueous electrolyte, typified by a lithium-ion secondary battery.

A lithium-ion secondary battery in which active material layers of a positive electrode and a negative electrode are each formed on a current collector composed of a low-melting (130° C. to 170° C.) resin film and metal layers on both sides thereof is reported in Japanese Unexamined Patent Publication No. HEI 11 (1999)-102711 among many proposals for the function of preventing an abnormal heat generation state, which have heretofore been made.

In the secondary battery of the current collector including this resin film, in the case where an abnormal heat generation occurs by a short circuit due to an incorporated foreign matter between the positive electrode and the negative electrode, the low-melting resin film is molten down and the metal layers formed thereon are also broken, so that a current is cut. As a result, it is conceived in this publication that a temperature rise inside the secondary battery is restrained and an ignition can be prevented.

### SUMMARY OF THE INVENTION

Thus, the present invention provides a nonaqueous electrolyte secondary battery comprising electrodes composed of a positive and negative electrodes containing an active material, and a separator between the positive electrode and the negative electrode; wherein

one of the positive electrode and the negative electrode contains a binder and is formed on a current collector;

the current collector has a structure composed of a resin layer so as to melt upon an abnormal heat generation and metal layers as an electric conductor formed on both sides of the resin layer;

the resin layer has a melting point of 120 to 200° C.; and

the binder has a melting point between 70° C. and a lower temperature than above mentioned melting point of the resin layer by 40° C.

Also, the present invention provides an electrode for a positive electrode or a negative electrode of a nonaqueous electrolyte secondary battery, comprising electrodes composed of a positive electrode and a negative electrode, and a separator between the positive electrode and the negative electrode; wherein

one of the positive electrode and the negative electrode contains a binder and is formed on a current collector;

the current collector has a structure composed of a resin layer so as to melt upon an abnormal heat generation and metal layers as an electric conductor formed on both sides of the resin layer;

the resin layer has a melting point of 120 to 200° C.; and

the binder has a melting point between 70° C. and a lower temperature than above mentioned melting point of the resin layer by 40° C.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1A to 1C are schematic explanatory views of a reason that the secondary battery of the present invention can improve the safety.

### DETAILED DESCRIPTION OF THE PREFERRED EMBODIMENTS

The battery of the above publication uses polyvinylidene fluoride as the binder contained in the electrode. Thus, this battery is inferior in responsibility such that when a heat generation occurs at a short-circuit point, the resin film is molten down to break the metal film. In addition, with regard to this battery, in the case where a thickness of the electrode increases, a rate characteristic deteriorates and a sufficient charge and discharge characteristic is not obtained in some cases.

The nonaqueous electrolyte secondary battery (hereinafter, referred to also simply as secondary battery) of the present invention can improve the safety since:
the melting point of a resin layer composing the current collector on a positive electrode and/or a negative electrode sides is within a specific range, and
the melting point of a binder composing an electrode formed on the current collector having the resin layer with the melting point within the specific range is within a specific range in relation to the melting point of the resin layer. The inventors consider that a reason to improve the safety is based on the following mechanism.

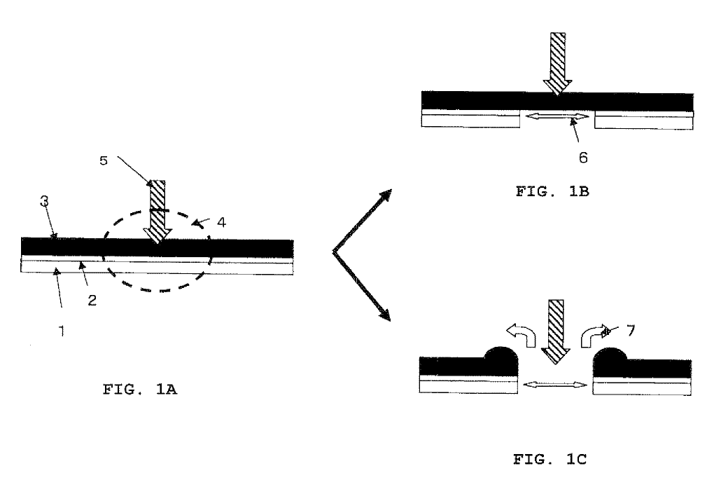

FIGS. 1A to 1C are schematic explanatory views of the reason that the secondary battery of the present invention can improve the safety. In the Figs., 1 means a resin layer, 2 means a metal layer, 3 means an electrode, 4 means a heat generation region, 5 means an internal short-circuit spot due to a foreign matter, 6 means a molten-down spot of the resin layer, and 7 means a molten-down spot of the electrode.

In FIG. 1A, a heat generation occurs in the internal short-circuit spot 5 due to a foreign matter or the like by a short circuit between the positive electrode and the negative electrode. The heat generation occurs in the region 4 around the internal short-circuit spot 5.

Conventionally, a resin with a higher melting point than that of the resin layer 1, such as polyvinylidene fluoride and a styrene-butadiene rubber, has been used for a binder composing an electrode. In the case of using the binder, as shown in FIG. 1B, the resin layer 1 is molten down in the spot 6 by the heat generation; however, the electrode 3 is not molten down and the heat generation by the short circuit continues, so as to further raise a temperature in the secondary battery.

On the contrary, in the present invention, the melting points of the resin layer 1 and the binder are within the specific range, which makes it possible to melt down the electrode 3 at approximately the same time as melting down the resin layer 1 in the spots 6 and 7 as shown in FIG. 1C. As a result, the short circuit is solved and the temperature in the secondary battery may be prevented from rising.

Hereinafter, components of the secondary battery of the present invention will be described. The components described below are one of examples and are not limited to the following examples; any component can be used if known for the secondary battery.

<Secondary Battery>

The present invention can be applied to any secondary battery being a nonaqueous electrolyte secondary battery. Examples of the secondary battery include a lithium-ion secondary battery, a metal lithium secondary battery, a lithium polymer secondary battery and a stationary large-sized lithium-ion secondary battery. Among these, the present invention is preferably applied to a lithium-ion secondary battery in which the improved safety is further required upon occurrence of a short-circuit current.

In the present invention, at least one electrode of the positive electrode and the negative electrode contains the binder and is formed on the current collector. The other electrode may or may not contain the binder, and may or may not be formed on the current collector. It is preferable from the viewpoint of further improving the safety that both the positive electrode and the negative electrode contain the binder and be formed on the current collector.

The secondary battery provided with a thick electrode in which a thickness of the electrode is 100 μm or more (more preferably, 100 to 1000 μm) is more appropriate. The secondary battery provided with this thick electrode is useful as a high capacity storage battery for a solar battery and a wind power generation. The thickness of the electrode means a total value of the thicknesses of the electrodes on both sides in the case where the electrode is formed on each of both sides of the current collector.

<Current Collector>

A material with an electric conductivity is used as the current collector for collecting a current from an ion given and received in the positive electrode and/or the negative electrode in accordance with charge and discharge of the secondary battery.

The current collector is provided with a structure composed of the resin layer so as to melt upon the abnormal heat generation and metal layers as the electric conductor formed on both sides of the resin layer. Here, the abnormal heat generation is a heat generation which affects the safety of the secondary battery, for example, meaning a heat generation of a higher temperature than the melting point of the resin layer.

(1) Resin layer

A layer composed of a resin having a melting point of 120 to 250° C. is used for the resin layer. The melting point in this range allows a function of collecting a current to be efficiently broken upon the abnormal heat generation. The lower limit of 120° C. is set from the viewpoint of a heat resistance of the battery. In the case of being higher than 250° C., a smoking or ignition occasionally occurs in the secondary battery from the viewpoint of a shutdown function of the current upon an internal short circuit. Thus, the current needs to be restrained at 250° C. or less. The melting point is more preferably 120 to 200° C. The melting point is a value measured in the following manner.

Device name: Differential Scanning calorimeter (DSC): Thermo Plus Evo (RIGAKU)

Measuring method: an active material layer of an electrode coated on a metallic foil is shaven off and taken by 10 mg. This is put into a cylindrical sample vessel made of aluminum (a pan made of Al) and further set in the DSC with a lid made of aluminum placed. The measurement is performed at a temperature of 30 to 350° C. to extract data every 10° C. However, Al₂O₃ is used for a reference.

The resin layer desirably has a property such that the resin is not attacked (not dissolved and swollen) by the nonaqueous electrolyte. Thus, the resin layer is desirably made of a polyolefin-based resin having such a property, which is typified by a polyethylene-based resin and a polypropylene-based resin. In addition, a polyethylene component and a polypropylene component composing the polyethylene-based resin and the polypropylene-based resin preferably exist in the resin layer in an amount as a main component (such as an amount more than 50% by weight). Other components except for the polyethylene component and the polypropylene component may be contained in the polyethylene-based resin and the polypropylene-based resin. Examples of the other components include other monomer components copolymerizable with ethylene and propylene, and other resins. Examples of the other monomers include hydrocarbons having two vinyl groups, such as butadiene, aromatic vinyl monomers such as styrene and α-methyl styrene, (meth)acrylate monomers such as methyl (meth)acrylate, ethyl (meth)acrylate and butyl (meth)acrylate, and vinyl acetate. The other resins exist in the resin in the form of a mixture with the polyethylene component and the polypropylene component. Examples of the other resins include a polyester-based resin, a fluorine-based resin, a polyimide-based resin, a polyamide (nylon)-based resin, and a cellulose-based resin.

A thickness of the resin layer is preferably in a range of 6 to 40 μm. In the case where the thickness is thinner than 6 μm, securing a supportability of the active material and securing a strength as the current collector may be insufficient. In the case of being thicker than 40 μm, a volume fraction of the current collector occupied in the secondary battery is increased so much that the battery capacity cannot be increased in some cases. The thickness is more preferably in a range of 6 to 20 μm.

(2) Metal layer

Kinds of metal layers formed on both sides of the resin layer are not particularly limited if their are layers which functions as an electric conductor. Examples of the metal layer include a film of a metal selected from nickel, copper, aluminum, titanium, and gold. Aluminum and copper are preferably used for the current collector on the positive electrode side and for the current collector on the negative electrode side, respectively.

The metal layer preferably has a resistivity of 1 mΩ/cm² or less from the viewpoint of securing a sufficient current collectability. The resistivity is more preferably 0.1 mΩ/cm² or less.

A thickness of the metal layer is preferably in a range of 2 to 10 μM. In the case where the thickness is thinner than 2 μm, the conductivity may be insufficient. In the case of being thicker than 10 μm, the volume fraction of the current collector occupied in the secondary battery is increased so much that the battery capacity cannot be increased in some cases. The thickness is more preferably in a range of 3 to 6 μm.

(3) A thickness of the whole current collector is preferably in a range of 0.05 to 10 mm. In the case where the thickness is thinner than 0.05 mm, securing the supportability of the active material and securing the strength as the current collector may be insufficient. In the case of being thicker than 10 mm, the volume fraction of the current collector occupied in the secondary battery is increased so much that the battery capacity cannot be increased in some cases. The thickness is more preferably in a range of 0.08 to 1 mm.

In the case where the other electrode is not formed on the current collector, examples of a constitution of the other electrode include a constitution in which a positive electrode active material itself also serves as the current collector, such as a lithium metal secondary battery.

<Binder>

The binder has a melting point between 70° C. and a lower temperature than above mentioned melting point of the resin layer by 40° C. The melting point in this range allows the function of collecting a current to be efficiently broken upon the abnormal heat generation. The heat resistance up to 70° C. is required for the secondary battery in the case of taking a general use environment into consideration. Therefore, the heat resistance in accordance with this is also required for a material composing the secondary electrode, so that the lower limit of the melting point of the binder is set at 70° C. The melting point is more preferably between 90° C. and a lower temperature than above mentioned melting point of the resin layer by 50° C.

Kinds of the binder are not particularly limited as far as it has the above-described melting point. Examples of the binder include polyolefin-based resins typified by a polyethylene-based resin and a polypropylene-based resin. A polyethylene component and a polypropylene component composing the polyethylene-based resin and the polypropylene-based resin preferably exist in the resin layer in an amount as a main component (such as an amount more than 50% by weight). Other components except for the polyethylene component and the polypropylene component may be contained in the polyethylene-based resin and the polypropylene-based resin. Examples of the other components include other monomer components copolymerizable with ethylene and propylene, and other resins. Examples of the other monomers include hydrocarbons having two vinyl groups, such as butadiene, aromatic vinyl monomers such as styrene and α-methyl styrene, (meth)acrylate monomers such as methyl (meth)acrylate, ethyl (meth)acrylate and butyl (meth)acrylate, and vinyl acetate. The other resins exist in the resin in the form of the mixture of the polyethylene component and the polypropylene component. Examples of the other resins include a polyester-based resin, a fluorine-based resin, a polyimide-based resin, a polyamide (nylon)-based resin, and a cellulose-based resin.

Examples of a combination of the resins composing the resin layer and the binder include a combination of a polypropylene-based resin and a polypropylene-based resin or a polyethylene-based resin and a combination of a polyethylene-based resin and a polyethylene-based resin.

A mixing ratio of these binders varies depending on kinds of the binders to be mixed and may be determined at 0.1 to 15 parts by weight with respect to 100 parts by weight of the positive electrode active material. When the binders are less than approximately 0.1 parts by weight, a binding capacity may become insufficient; meanwhile, when the binders are more than approximately 15 parts by weight, the amount of the active material contained in the positive electrode decreases and a resistance or a polarization of the positive electrode increases, so that a discharge capacity may decrease. The mixing ratio is more preferably 0.5 to 8.0 parts by weight.

<Electrode>

The electrode contains a positive electrode active material in the case of being the positive electrode and a negative electrode active material in the case of being the negative electrode, except for the binder.

(1) Positive Electrode Active Material

Examples of the positive electrode active material include metal lithium and oxides containing lithium. Specific examples of oxides include LiCoO₂, LiNiO₂, LiFeO₂, LiMnO₂, LiMn₂O₄, and a compound obtained by partially substituting a transition metal in these oxides with another metallic element. Above all, in an ordinary use, one in which 80% or more of the lithium amount in the positive electrode may be utilized for a battery reaction is preferably used for the positive electrode active material. Thus, the safety of the secondary battery against an accident such as overcharge may be improved. Examples of this positive electrode active material include compounds having a spinel structure, such as LiMn₂O₄, and compounds having an olivine structure represented by LiMPO₄ (M is at least one element selected from Co, Ni, Mn and Fe). Above all, the positive electrode active material containing Mn and/or Fe is preferable from the viewpoint of a cost. In addition, LiFePO₄ is preferable from the viewpoint of the safety and a charging voltage. LiFePO₄ is excellent in safety for the reason that all oxygen atoms bond to phosphorus by a firm covalent bond and an emission of oxygen by a temperature rise is hardly caused. Since LiFePO₄ contain phosphorus, an anti-inflammatory action can also be expected.

A used amount of the positive electrode active material per positive electrode area is preferably between 18 to 42 mg/cm². When the used amount is less than 18 mg/cm², a sufficient battery performance cannot be secured in some cases; meanwhile, when the used amount is more than 42 mg/cm², occasionally an increase in resistance value at the short-circuit point may not occur even in the case where the abnormal heat generation occurs in the battery. The used amount is more preferably between 25 to 35 mg/cm².

A density of the positive electrode active material is preferably between 1.6 to 2.2 g/cm³. When the density is less than 1.6 g/cm³, a thermal conductivity between the active materials is so low that the abnormal heat generation in a short-circuit region does not sufficiently propagate to the current collector and occasionally the increase in resistance value by a melting of the current collector may not occur; meanwhile, when the density is more than 2.2 g/cm³, the thermal conductivity between the active materials is so high that the abnormal heat generation in a short-circuit region diffuses into the active materials and occasionally the increase in resistance value by a melting of the current collector may not occur. The density is more preferably between 1.8 to 2.0 g/cm³.

(2) Negative Electrode Active Material

A graphite carbon material may be ordinarily used as the negative electrode active material. Examples of the graphite carbon material include natural graphite, particulate (such as flake-like, massive, fibrous, whisker-like, spherical or granular) artificial graphite, highly crystalline graphite typified by a graphitized product such as a mesocarbon microbead, a mesophase pitch powder or an isotropic pitch powder, and non-graphitizable carbon such as resin baked carbon. In addition, a mixture thereof may be used. Tin oxide, a silicon-based negative electrode active material, and an alloy-based negative electrode active material with a large capacity may also be used. Above all, a graphite carbon material is preferable in being capable of achieving a higher energy density for the reason that an electric potential of the charge and discharge reaction is high in flatness and is close to a dissolution deposition potential of metal lithium. In addition, a graphite powder material with amorphous carbon adhered to a surface is preferable in being capable of restraining the decomposition reaction of the nonaqueous electrolyte associated with charge and discharge to decrease a gas generation in the secondary battery.

The graphite carbon material as the negative electrode active material is preferably a particulate matter and an average particle diameter thereof is preferably 2 to 50 μm, more preferably 5 to 30 μm. When the average particle diameter is less than 2 μm, the negative electrode active material occasionally passes through a pore of a separator and the negative electrode active material passed therethrough may short-circuit the secondary battery. On the other hand, when the average particle diameter is more than 50 μm, the negative electrode may be hardly molded. In addition, a specific surface area of the graphite carbon material is preferably 1 to 100 m²/g, more preferably 2 to 20 m²/g. When the specific surface area is less than 1 m²/g, a region for allowing an insertion/elimination reaction of lithium may decrease to deteriorate a high-current discharge performance of the secondary battery. On the other hand, when the specific surface area is more than 100 m²/g, a place, where the decomposition reaction of the nonaqueous electrolyte on the negative electrode active material surface occurs, may increase to cause a gas generation in the secondary battery. Here, in the present specification, the average particle diameter and the specific surface area are values measured by using an automatic gas/vapor absorbed amount measuring apparatus BELSORP18 manufactured by BEL Japan, Inc.

A used amount of the negative electrode active material per negative electrode area is preferably between 11 to 24 mg/cm². When the used amount is less than 11 mg/cm², the sufficient battery performance cannot be secured in some cases; meanwhile, when the used amount is more than 24 mg/cm², occasionally the increase in resistance value at a short-circuit point may not occur even in the case where the abnormal heat generation occurs in the battery. The used amount is more preferably between 14 to 21 mg/cm².

A density of the negative electrode active material is preferably between 1.1 to 1.6 g/cm³. When the density is less than 1.1 g/cm³, a thermal conductivity between the active materials is so low that the abnormal heat generation in the short-circuit region does not sufficiently propagate to the current collector and occasionally the increase in resistance value by a melting of the current collector may not occur; meanwhile, when the density is more than 1.6 g/cm³, the thermal conductivity between the active materials is so high that the abnormal heat generation in a short-circuit region diffuses into the active materials and occasionally the increase in resistance value by a melting of the current collector may not occur. The density is more preferably between 1.3 to 1.5 g/cm³.

(3) Other Additives

The positive electrode and/or the negative electrode may contain a conductive material and a thickening material except for the active material and the binder.

Examples of the conductive material include a carbonaceous material such as acetylene black, ketjen black and graphite (natural graphite and artificial graphite).

Examples of the thickening material include polyethylene glycols, celluloses, polyacrylamides, poly-N-vinylamides and poly-N-vinylpyrrolidones; among these, polyethylene glycol and cellulose such as carboxymethyl cellulose (CMC) are preferable, and CMC is particularly preferable.

The mixing ratio of the thickening material and the conductive material vary with kinds of the thickening material and the conductive material to be mixed, and may be set at approximately 0.1 to 20 parts by weight and approximately 0.1 to 50 parts by weight respectively with respect to 100 parts by weight of the active material. When the thickening material is less than approximately 0.1 parts by weight, a thickening capacity may become insufficient; meanwhile, when the thickening material is more than approximately 20 parts by weight, the active material amount contained in the electrode decreases and a resistance or a polarization of the electrode increases, so that a discharge capacity may decrease. In addition, when the conductive material is less than approximately 0.1 parts by weight, a resistance or a polarization of the electrode increases, so that a discharge capacity decreases occasionally; meanwhile, when the conductive material is more than approximately 50 parts by weight, the active material amount contained in the electrode decreases, so that a discharge capacity as the electrode may decrease.

(4) Producing Method for Electrode

The electrode may be produced by a known method. For example, the electrode may be produced in such a manner that a paste in which the active material and the binder, optionally the conductive material and the thickening material, are dispersed into a solvent is applied and dried to the current collector. Examples of the solvent include water, N-methyl-2-pyrrolidone (NMP) and N,N-dimethylformamide (DMF). A used amount of the solvent is not particularly limited and an amount for imparting a viscosity, such that the paste can be applied to the current collector, to the paste.

<Separator>

An insulating thin film, which is high in ion permeability and has a predetermined mechanical strength, may be used for the separator. A material composing the separator is not particularly limited but may be such as to be unaffected by the nonaqueous electrolyte. Examples thereof include polyolefin-based resins such as polyethylene, polypropylene and poly-4-methylpentene-1, polyester-based resins such as polyethylene terephthalate, polybutylene terephthalate, polyethylene naphthalate and polytrimethylene terephthalate, polyamide-based resins such as 6-nylon, 66-nylon and a wholly aromatic polyamide, a fluorine-based resin, a polyimide-based resin, a cellulose-based resin, an aramid-based resin, and a glass fiber. These resins may be mixed by two kinds or more. Examples of a form of the separator include a nonwoven fabric, a woven fabric and a microporous film.

In particular, a nonwoven fabric and a microporous film made of polyethylene, polypropylene, polyester or the like are preferable in view of a quality stability. In the nonwoven fabric and the microporous film of these synthetic resins, a function (a shutdown) such that the separator melts by heat to interrupt between the positive and negative electrodes in the case where the secondary battery generates heat abnormally is added to the secondary battery.

A polyimide-based resin, a polyamide-based resin and an aramid-based resin are so excellent in form-stability as to have a merit of being form-stable even though the temperature rises.

<Nonaqueous Electrolyte>

The nonaqueous electrolyte is not particularly limited and examples thereof include a solution obtained by dissolving an electrolyte salt in an organic solvent.

In the case of being used for a lithium-ion secondary battery, examples of the electrolyte salt include a lithium salt having lithium as a cationic component and a lithium salt having organic acid such as fluorine-substituted organic sulfonic acid as an anionic component, such as lithium borofluoride, lithium hexafluorophosphate and lithium perchlorate.

Any organic solvent may be used if it dissolves the above-described electrolyte salt. Examples thereof include cyclic carbonates such as ethylene carbonate, propylene carbonate and butylene carbonate, cyclic esters such as γ-butyrolactone, ethers such as tetrahydrofuran and dimethoxyethane, and chain carbonates such as dimethyl carbonate, diethyl carbonate and ethyl methyl carbonate. These organic solvents are used singly or as a mixture of two kinds or more.

<Constitution of Secondary Battery>

Plural positive electrodes and plural negative electrodes may be laminated via the separators. Examples include a laminated constitution such as to repeat negative electrode/separator/positive electrode/separator/negative electrode/separator/positive electrode. The number of a lamination may be determined in accordance with the desired battery capacity. The present invention can provide the secondary battery such that the safety is improved even in such a high capacity as 4 Ah or more (such as 4 to 200 Ah). Also, the present invention can provide the secondary battery with the improved safety, having the capacity of 90 Ah/m² or more per area of the positive electrode or the negative electrode.

### EXAMPLES

Hereinafter, the present invention will be described in more detail while referring to examples, but it is not limited thereto. Abbreviations in the following examples are shown in the following Table 1.

TABLE 1

| | |
|---|---|
| PE | Polyethylene |
| PP | Polypropylene |
| PET | Polyethylene terephthalate |
| EC | Ethylene carbonate |
| DEC | Diethyl carbonate |
| MEC | Methyl ethyl carbonate |
| VC | Vinylene carbonate |
| SBR | Styrene-butadiene rubber |
| PVDF | Polyvinylidene fluoride |
| NMP | N-methyl pyrrolidone |

### Example 1

A positive electrode current collector was obtained by laminating aluminum foils with a thickness of 6 μm on both sides of a polyethylene-based resin layer (a melting point of 120° C.) with a thickness of 20 μm.

Next, a 1.5% by weight-CMC aqueous solution (a thickening material) was produced by 1 part by weight, and thereto added were 10 parts by weight of a conductive material (DENKA BLACK: artificial graphite manufactured by Denki Kagaku Kogyo K.K., a particle diameter of 100 nm), 100 parts by weight of a positive electrode active material (iron phosphate lithium: iron phosphate lithium manufactured by Mitsui Engineering & Shipbuilding Co., Ltd., a particle diameter of 100 nm) and 2 parts by weight of a binder (PE-vinyl acetate: V100 manufactured by Mitsui Chemicals, Inc., a melting point of 75° C. or less and 70° C. or more) in this order while kneading, to obtain a positive electrode paste. DAICEL 2000 manufactured by Daicel Chemical Industries, Ltd. (a degree of etherification of 0.8 to 1.0, a viscosity of a 1% by weight aqueous solution of 1500 to 2000 cps) was used for the CMC. The obtained positive electrode paste was applied on both sides of the positive electrode current collector by an application amount such that the positive electrode active material was contained in an amount of 25.5 mg/cm² (a total value of both sides), and dried provisionally at 80° C. and thereafter dried regularly in vacuo at the same temperature to thereby obtain a positive electrode with a density of the positive electrode active material of 1.9 g/cm³.

A negative electrode paste was obtained in the same manner as the positive electrode paste except for using 100 parts by weight of GP837C manufactured by Hitachi Powdered Metals Co., Ltd. (natural graphite, a particle diameter of 16 μm) as a negative electrode active material, 10 parts by weight of SFG6 manufactured by TIMCALJAPAN (artificial graphite, a particle diameter of 6 μm) as a conductive material and 2 parts by weight of the binder (PE-vinyl acetate: V100 manufactured by Mitsui Chemicals, Inc., a melting point of 75° C. or less and 70° C. or more). The obtained negative electrode paste was applied on both sides of a Cu foil (a thickness of 10 μm) as a negative electrode current collector by an application amount such that the negative electrode active material was contained in an amount of 15 mg/cm² (a total value of both sides), and dried provisionally at 80° C. and thereafter dried regularly in vacuo at the same temperature to thereby obtain a negative electrode with a density of the negative electrode active material of 1.5 g/cm³.

A battery element by 10 cells was obtained by laminating a separator, a positive electrode element (a laminated body of the positive electrode, the positive electrode current collector and the positive electrode) and a negative electrode element (a laminated body of the negative electrode, the negative electrode current collector and the negative electrode) in the order of negative electrode element/separator/positive electrode element/separator/negative electrode element/ . . . /negative electrode element/separator/positive electrode element/separator/negative electrode element (the number of the positive electrode elements: 9, the number of the negative electrode elements: 10). In addition, a tab was welded to each of the positive electrode current collector and the negative electrode current collector. The obtained battery element was inserted into a can. KKC-1424AR (no melting point) manufactured by Vilene Co., Ltd. as an aramid-based resin was used for the separator. An area of a plane crossing with a lamination direction of the positive electrode and the negative electrode was set to 98 cm².

A solution in which LiPF₆ and vinylene carbonate were dissolved so as to be 1M and 1% by weight respectively in a solvent such that an ethylene carbonate (EC) and a dimethyl carbonate (DMC) were mixed so as to be at a volume ratio of 1:2 was used for a nonaqueous electrolyte. This nonaqueous electrolyte was poured into the can and retained under a reduced pressure. Subsequently, after returning to an atmospheric pressure, an outer circumference of a lid was sealed to produce five secondary batteries with a capacity of 4 Ah (5 samples).

The obtained secondary battery was subjected to a nail penetration test on the following conditions. The results are shown in Table 3.

(Nail Penetration Test)

After the secondary battery was fully charged by a CC-CV charge (a charging current of 400 mA, a final voltage of 3.8 V, a final current of 40 mA), a 2.5-mmφ nail penetrated on the condition of a nail penetration rate of 1 mm/s from a direction along the lamination direction of the positive electrode and the negative electrode. A behavior of the secondary battery after the penetration was observed to measure a surface temperature thereof. With regard to the surface temperature, a maximum temperature at each of 4 points was measured for each of the samples. 4 points were away from a penetrated region by 2 cm in a surface direction of the negative electrode. An average value of the maximum temperatures at 20 points (4 points×5 samples) was regarded as a maximum end-point temperature.

The behavior of the secondary battery was classified into three kinds of ‘no smoking’, ‘smoking’ and ‘ignition’ for the secondary battery after 30 minutes from the penetration, and the secondary battery evaluated as ‘no smoking’ in all of 5 samples was evaluated as safe.

### Examples 2 to 10 and Comparative Examples 1 to 6

A secondary battery was obtained in the same manner as in Example 1 except for adopting a battery structure shown in Table 2 and a binder shown in Tables 3 and 4. A Cu foil-PE multi-layer structure as the negative electrode current collector was obtained by laminating a Cu foil with a thickness of 6 μm on both sides of a polyethylene-based resin layer (a melting point of 120° C.) with a thickness of 20 μm In Table 2, ‘lamination number of positive/negative’ signifies the lamination number of the positive electrode elements and the negative electrode elements.

The obtained secondary battery was subjected to the nail penetration test. The results are shown in Tables 3 and 4.

TABLE 2

| | | Positive electrode | | | Negative electrode | | | | | |
|---|---|---|---|---|---|---|---|---|---|---|
| | Positive | active material | | Negative | active material | | | | Lamination | |
| | electrode | Application | | electrode | Application | | | | number of | Battery |
| Battery | current | amount | Density | current | amount | Density | | Nonaqueous | positive/ | capacity |
| structure | collector | mg/cm² | g/cm³ | collector | mg/cm² | g/cm³ | Separator | electrolyte | negative | Ah |
| Structure I | Al foil-PE | 25.5 | 1.9 | Cu foil | 15 | 1.5 | Aramid- | EC-DEC | 9/10 | 4 |
| | multi-layer | | | | | | based | (1:2) | | |
| | structure | | | | | | | 1M LipF6 | | |
| | (melting | | | | | | | 1% VC | | |
| | point of | | | | | | | | | |
| | 150° C.) | | | | | | | | | |
| Structure II | Al foil | 25.5 | 1.9 | Cu foil-PE multi-layer | 15 | 1.5 | Aramid- | EC-DEC | 9/10 | 4 |
| | | | | structure | | | based | (1:2) | | |
| | | | | (melting point | | | | 1M LipF6 | | |
| | | | | of 150° C.) | | | | 1% VC | | |

TABLE 3

| | | | | | | Nail penetration test result | | | |
|---|---|---|---|---|---|---|---|---|---|
| | | Binder | | | | Maximum | | | |
| | | | | | Melting | end-point | | | |
| | Battery | | Trade name | | point | temperature | | | |
| | structure | Abbreviation | (company name) | Resin kind | ° C. | ° C. | No smoking | Smoking | Ignition |
| Example 1 | Structure I | A | V100 (Mitsui | PE- | <75 | 170 | 5 | 0 | 0 |
| | | | Chemicals, Inc.) | vinyl acetate | | | | | |
| Example 2 | Structure I | B | S75N (Mitsui | PE | 75 | 165 | 5 | 0 | 0 |
| | | | Chemicals, Inc.) | | | | | | |
| Example 3 | Structure I | C | S650 (Mitsui | PE | 90 | 170 | 5 | 0 | 0 |
| | | | Chemicals, Inc.) | | | | | | |
| Example 4 | Structure I | D | S300 (Mitsui | PE | 100 | 170 | 5 | 0 | 0 |
| | | | Chemicals, Inc.) | | | | | | |
| Example 5 | Structure I | E | M200 (Mitsui | PE | 110 | 180 | 5 | 0 | 0 |
| | | | Chemicals, Inc.) | | | | | | |
| Comparative | Structure I | F | W300 (Mitsui | PE | 120 | 210 | 2 | 3 | 0 |
| Example 1 | | | Chemicals, Inc.) | (Low molecular | | | | | |
| | | | | weight) | | | | | |
| Comparative | Structure I | G | WP100 (Mitsui | PP | 140 | 230 | 1 | 4 | 0 |
| Example 2 | | | Chemicals, Inc.) | | | | | | |
| Comparative | Structure I | H | TRD2001 | SBR | >180 | >250 | 0 | 1 | 4 |
| Example 3 | | | (JSR) | | | | | | |

TABLE 4

| | | | | | | Nail penetration test result | | | |
|---|---|---|---|---|---|---|---|---|---|
| | | Binder | | | | Maximum | | | |
| | | | | | Melting | end-point | | | |
| | Battery | | Trade name | | point | temperature | No | | |
| | structure | Abbreviation | (company name) | Resin kind | ° C. | ° C. | smoking | Smoking | Ignition |
| Example 6 | Structure II | A | V100 (Mitsui | PE-vinylacetate | <75 | 180 | 5 | 0 | 0 |
| | | | Chemicals, Inc.) | | | | | | |
| Example 7 | Structure II | B | S75N (Mitsui | PE | 75 | 170 | 5 | 0 | 0 |
| | | | Chemicals, Inc.) | | | | | | |
| Example 8 | Structure II | C | S650 (Mitsui | PE | 90 | 185 | 5 | 0 | 0 |
| | | | Chemicals, Inc.) | | | | | | |
| Example 9 | Structure II | D | S300 (Mitsui | PE | 100 | 185 | 5 | 0 | 0 |
| | | | Chemicals, Inc.) | | | | | | |
| Example 10 | Structure II | E | M200 (Mitsui | PE | 110 | 190 | 5 | 0 | 0 |
| | | | Chemicals, Inc.) | | | | | | |
| Comparative | Structure II | F | W300 (Mitsui | PE | 120 | 215 | 2 | 3 | 0 |
| Example 4 | | | Chemicals, Inc.) | (Low molecular | | | | | |
| | | | | weight) | | | | | |
| Comparative | Structure II | G | WP100 (Mitsui | PP | 140 | 235 | 0 | 3 | 2 |
| Example 5 | | | Chemicals, Inc.) | | | | | | |
| Comparative | Structure II | H | TRD2001 | SBR | >180 | >250 | 0 | 0 | 5 |
| Example 6 | | | (JSR) | | | | | | |

From Examples, in the case of providing the metal-resin multi-layer structure in each of the positive electrode side and the negative electrode side, the safety by the nail penetration test was confirmed in such a range that the melting point of the binder of both was up to 110° C. However, in the case of using the binder with a melting point higher than 110° C., smoking or ignition was observed in the nail penetration test. The reason therefore is conceived to be that a binding of the active material layer at a melting temperature of the current collector was so firm that the melting of the electrode did not sufficiently follow the melting of the current collector and a development of a current restraint effect was too late.

From the foregoing, it is found that since it is conceived that a balance between the melting point of the resin layer and the melting point of the binder influences a more effective development of the safety function, the melting point of the binder is desirably lower than the melting point of the resin layer by 40° C. or more.

### Examples 11 to 15

As shown in Table 5, a secondary battery was obtained in the same manner as in Example 5 except for modifying the application amount of the positive electrode active material, the application amount of the negative electrode active material, and the lamination number of the positive electrode elements and the negative electrode elements while maintaining the battery capacity at 4 Ah. The obtained secondary battery was subjected to the nail penetration test. The results are shown in Table 5.

### Examples 16 to 20

As shown in Table 5, a secondary battery was obtained in the same manner as in Example 10 except for modifying the application amount of the positive electrode active material, the application amount of the negative electrode active material, and the lamination number of the positive electrode elements and the negative electrode elements while maintaining the battery capacity at 4 Ah. The obtained secondary battery was subjected to the nail penetration test. The results are shown in Table 5.

### Comparative Examples 7 to 11

As shown in Table 6, a secondary battery was obtained in the same manner as in Comparative Example 1 except for modifying the application amount of the positive electrode active material, the application amount of the negative electrode active material, and the lamination number of the positive electrode elements and the negative electrode elements while maintaining the battery capacity at 4 Ah. The obtained secondary battery was subjected to the nail penetration test. The results are shown in Table 6.

### Comparative Examples 12 to 16

As shown in Table 6, a secondary battery was obtained in the same manner as in Comparative Example 4 except for modifying the application amount of the positive electrode active material, the application amount of the negative electrode active material, and the lamination number of the positive electrode elements and the negative electrode elements while maintaining the battery capacity at 4 Ah. The obtained secondary battery was subjected to the nail penetration test. The results are shown in Table 6.

TABLE 5

| | | Positive electrode | | | Negative electrode | | | |
|---|---|---|---|---|---|---|---|---|
| | Positive | active material | | Negative | active material | | | |
| | electrode | Application | | electrode | Application | | | |
| | current | amount | Density | current | amount | Density | | Nonaqueous |
| Examples | collector | mg/cm² | g/cm² | collector | mg/cm² | g/cm² | Separator | electrolyte |
| 11 | Al foil-PE | 10 | 1.9 | Cu foil | 5 | 1.5 | Aramid- | EC-DEC (1:2) |
| | multi-layer | | | | | | based | 1M LiPF6 |
| | structure | | | | | | | 1% VC |
| | (melting point | | | | | | | |
| | of 150° C.) | | | | | | | |
| 12 | As above | 17 | 1.9 | As above | 10 | 1.5 | Aramid- | As above |
| | | | | | | | based | |
| 13 | As above | 25.5 | 1.9 | As above | 15 | 1.5 | Aramid- | As above |
| | | | | | | | based | |
| 14 | As above | 34 | 1.9 | As above | 20 | 1.5 | Aramid- | As above |
| | | | | | | | based | |
| 15 | As above | 42.5 | 1.9 | As above | 25 | 1.5 | Aramid- | As above |
| | | | | | | | based | |
| 16 | Al foil | 10 | 1.9 | Cu foil-PE | 5 | 1.5 | Aramid- | EC-MEC (1:2) |
| | | | | multi-layer | | | based | 1M LiPF6 |
| | | | | structure | | | | 1% VC |
| | | | | (melting point | | | | |
| | | | | of 150° C.) | | | | |
| 17 | As above | 17 | 1.9 | As above | 10 | 1.5 | Aramid- | As above |
| | | | | | | | based | |
| 18 | As above | 25.5 | 1.9 | As above | 15 | 1.5 | Aramid- | As above |
| | | | | | | | based | |
| 19 | As above | 34 | 1.9 | As above | 20 | 1.5 | Aramid- | As above |
| | | | | | | | based | |
| 20 | As above | 42.5 | 1.9 | As above | 25 | 1.5 | Aramid- | As above |
| | | | | | | | based | |

| | | | | Nail penetration test result | | | |
|---|---|---|---|---|---|---|---|
| | | | | Maximum | | | |
| | Lamination | | | end-point | | | |
| | number of | | Battery capacity | temperature | | | |
| Examples | positive/negative | Binder | Ah | ° C. | No smoking | Smoking | Ignition |
| 11 | 18/19 | E | 4 | 160 | 5 | 0 | 0 |
| 12 | 9/10 | E | 4 | 170 | 5 | 0 | 0 |
| 13 | 6/7 | E | 4 | 180 | 5 | 0 | 0 |
| 14 | 5/5 | E | 4 | 185 | 5 | 0 | 0 |
| 15 | 4/4 | E | 4 | 200 | 5 | 0 | 0 |
| 16 | 18/19 | E | 4 | 170 | 5 | 0 | 0 |
| 17 | 9/10 | E | 4 | 180 | 5 | 0 | 0 |
| 18 | 6/7 | E | 4 | 190 | 5 | 0 | 0 |
| 19 | 5/5 | E | 4 | 195 | 5 | 0 | 0 |
| 20 | 4/4 | E | 4 | 205 | 5 | 0 | 0 |

TABLE 6

| | | Positive electrode | | | Negative electrode | | | |
|---|---|---|---|---|---|---|---|---|
| | Positive | active material | | Negative | active material | | | |
| | electrode | Application | | electrode | Application | | | |
| Comparative | current | amount | Density | current | amount | Density | | Nonaqueous |
| Examples | collector | mg/cm² | g/cm² | collector | mg/cm² | g/cm² | Separator | electrolyte |
| 7 | Al foil-PE | 10 | 1.9 | Cu foil | 5 | 1.5 | Aramid- | EC-DEC (1:2) |
| | multi-layer | | | | | | based | 1M LiPF6 |
| | structure | | | | | | | 1% VC |
| | (melting point | | | | | | | |
| | of 150° C.) | | | | | | | |
| 8 | As above | 17 | 1.9 | As above | 10 | 1.5 | Aramid- | As above |
| | | | | | | | based | |
| 9 | As above | 25.5 | 1.9 | As above | 15 | 1.5 | Aramid- | As above |
| | | | | | | | based | |
| 10 | As above | 34 | 1.9 | As above | 20 | 1.5 | Aramid- | As above |
| | | | | | | | based | |
| 11 | As above | 42.5 | 1.9 | As above | 25 | 1.5 | Aramid- | As above |
| | | | | | | | based | |
| 12 | Al foil | 10 | 1.9 | Cu foil-PE | 5 | 1.5 | Aramid- | EC-MEC (1:2) |
| | | | | multi-layer | | | based | 1M LiPF6 |
| | | | | structure | | | | 1% VC |
| | | | | (melting point | | | | |
| | | | | of 150° C.) | | | | |
| 13 | As above | 17 | 1.9 | As above | 10 | 1.5 | Aramid- | As above |
| | | | | | | | based | |
| 14 | As above | 25.5 | 1.9 | As above | 15 | 1.5 | Aramid- | As above |
| | | | | | | | based | |
| 15 | As above | 34 | 1.9 | As above | 20 | 1.5 | Aramid- | As above |
| | | | | | | | based | |
| 16 | As above | 42.5 | 1.9 | As above | 25 | 1.5 | Aramid- | As above |
| | | | | | | | based | |

| | | | | Nail penetration test result | | | |
|---|---|---|---|---|---|---|---|
| | | | | Maximum | | | |
| | Lamination | | | end-point | | | |
| Comparative | number of | | Battery capacity | temperature | | | |
| Examples | positive/negative | Binder | Ah | ° C. | No smoking | Smoking | Ignition |
| 7 | 18/19 | F | 4 | 190 | 4 | 1 | 0 |
| 8 | 9/10 | F | 4 | 200 | 4 | 1 | 0 |
| 9 | 6/7 | F | 4 | 210 | 2 | 3 | 0 |
| 10 | 5/5 | F | 4 | 230 | 2 | 3 | 0 |
| 11 | 4/4 | F | 4 | >250 | 0 | 1 | 4 |
| 12 | 18/19 | F | 4 | 190 | 4 | 1 | 0 |
| 13 | 9/10 | F | 4 | 205 | 3 | 2 | 0 |
| 14 | 6/7 | F | 4 | 215 | 2 | 3 | 0 |
| 15 | 5/5 | F | 4 | 240 | 0 | 5 | 0 |
| 16 | 4/4 | F | 4 | >250 | 0 | 0 | 5 |

From Tables 5 and 6, in the case where the positive electrode active material and the negative electrode active material were as small the application amount as approximately 10 mg/cm² and 5 mg/cm² respectively, a difference in the safety of the secondary battery between Examples and Comparative Examples is small.

It is found that in the case where the positive electrode active material and the negative electrode active material were applied by more than 17 mg/cm² and 10 mg/cm² respectively, the difference in the melting point of the binder influences the safety.

In the case where the positive electrode active material and the negative electrode active material were applied by 42.5 mg/cm² or more and 25 mg/cm² or more respectively, as shown in Comparative Examples, smoking and ignition are caused as a result of the nail penetration test. That is to say, it is conceived that too much application amount may render insufficient a responsibility of an inhibitory function against an abnormal current due to an internal short circuit.

### Examples 21 to 32

As shown in Table 7, secondary batteries of Examples 21 to 26 were obtained in the same manner as in Example 5 except for modifying the density of the positive electrode active material and the density of the negative electrode active material while maintaining the battery capacity at 4 Ah. The obtained secondary batteries were subjected to the nail penetration test. The results are shown in Table 7.

As shown in Table 7, secondary batteries of Examples 27 to 32 were obtained in the same manner as in Example 10 except for modifying the density of the positive electrode active material and the density of the negative electrode active material while maintaining the battery capacity at 4 Ah. The obtained secondary batteries were subject to the nail penetration test. The results are shown in Table 7.

TABLE 7

| | | Positive electrode | | | Negative electrode | | |
|---|---|---|---|---|---|---|---|
| | Positive | active material | | Negative | active material | | |
| | electrode | Application | | electrode | Application | | |
| | current | amount | Density | current | amount | Density | |
| Examples | collector | mg/cm² | g/cm² | collector | mg/cm² | g/cm² | Separator |
| 21 | Al foil-PE multi-layer | 25.5 | 1.4 | Cu foil | 15 | 1.5 | Aramid- |
| | structure | | | | | | based |
| | (melting point of 150° C.) | | | | | | |
| 22 | As above | 25.5 | 1.6 | As above | 15 | 1.5 | Aramid- |
| | | | | | | | based |
| 23 | As above | 25.5 | 1.8 | As above | 15 | 1.5 | Aramid- |
| | | | | | | | based |
| 24 | As above | 25.5 | 2 | As above | 15 | 1.5 | Aramid- |
| | | | | | | | based |
| 25 | As above | 25.5 | 2.2 | As above | 15 | 1.5 | Aramid- |
| | | | | | | | based |
| 26 | As above | 25.5 | 2.4 | As above | 15 | 1.5 | Aramid- |
| | | | | | | | based |
| 27 | Al foil | 25.5 | 1.9 | Cu foil-PE multi-layer | 15 | 1.1 | Aramid- |
| | | | | structure | | | based |
| | | | | (melting point of 150° C.) | | | |
| 28 | As above | 25.5 | 1.9 | As above | 15 | 1.3 | Aramid- |
| | | | | | | | based |
| 29 | As above | 25.5 | 1.9 | As above | 15 | 1.5 | Aramid- |
| | | | | | | | based |
| 30 | As above | 25.5 | 1.9 | As above | 15 | 1.6 | Aramid- |
| | | | | | | | based |
| 31 | As above | 25.5 | 1.9 | As above | 15 | 1.7 | Aramid- |
| | | | | | | | based |
| 32 | As above | 25.5 | 1.9 | As above | 15 | 1.9 | Aramid- |
| | | | | | | | based |

| | | | | | Nail penetration test result | | | |
|---|---|---|---|---|---|---|---|---|
| | | | | | Maximum | | | |
| | | | | | end-point | | | |
| | Nonaqueous | | Lamination number | Battery capacity | temperature | | | |
| Examples | electrolyte | Binder | of positive/negative | Ah | ° C. | No smoking | Smoking | Ignition |
| 21 | EC-DEC (1:2) | E | 6/7 | 4 | 200 | 5 | 0 | 0 |
| | 1M LiPF6 | | | | | | | |
| | 1% VC | | | | | | | |
| 22 | As above | E | 6/7 | 4 | 185 | 5 | 0 | 0 |
| 23 | As above | E | 6/7 | 4 | 170 | 5 | 0 | 0 |
| 24 | As above | E | 6/7 | 4 | 180 | 5 | 0 | 0 |
| 25 | As above | E | 6/7 | 4 | 190 | 5 | 0 | 0 |
| 26 | As above | E | 6/7 | 4 | 205 | 5 | 0 | 0 |
| 27 | EC-MEC (1:2) | E | 6/7 | 4 | 200 | 5 | 0 | 0 |
| | 1M LiPF6 | | | | | | | |
| | 1% VC | | | | | | | |
| 28 | As above | E | 6/7 | 4 | 195 | 5 | 0 | 0 |
| 29 | As above | E | 6/7 | 4 | 190 | 5 | 0 | 0 |
| 30 | As above | E | 6/7 | 4 | 195 | 5 | 0 | 0 |
| 31 | As above | E | 6/7 | 4 | 195 | 5 | 0 | 0 |
| 32 | As above | E | 6/7 | 4 | 205 | 5 | 0 | 0 |

From Table 7, it is found that in the case where the active material is contained in the electrode at the density of 1.6 to 2.2 g/cm³ in the case of the positive electrode and 1.1 to 1.6 g/cm³ in the case of the negative electrode, the safety can be further improved. It is conceived that in the case where the density of the active material is low, the thermal conductivity of the electrode in a thickness direction may decrease to slow down a response of a safety mechanism. Further, it is conceived that in the case where the density of the active material is high, a diffusion of heat of the electrode in an area direction may increase to locally conduct heat with a difficulty and consequently slow down a response of a safety mechanism.

### Example 33

It can be presumed that a secondary battery obtained in the same manner as in Example 1 except for using the separator, the resin layer of the current collector, and the binder shown in the following Table 8 also allows nearly the same safety as in Example 1.

TABLE 8

| | Separator | Current collector resin | Binder |
|---|---|---|---|
| Combination | Aramid-based | PET | PP |
| example 1 | resin | | |
| Combination | Aramid-based | PET | PE |
| example 2 | resin | | |
| Combination | Aramid-based | PE (High melting point) | PE (Low |
| example 3 | resin | | melting point) |
| Combination | PP High | PP (Low melting point) | PE |
| example 4 | melting point | | |
| Combination | PP | PE (High melting point) | PE (Low |
| example 5 | | | melting point) |

In the above Table, an aramid-based resin, PP and PE are the same as up to Example 32. PP (high melting point) has the melting point of 180° C. and PP (low melting point) has the melting point of 160° C. PE (high melting point) has the melting point of 150° C. and PE (low melting point) has the melting point of 120° C. PET has the melting point of 230° C.

### Examples 34 to 41 and Comparative Examples 17 to 20

A secondary battery was obtained in the same manner as in Example 1 except for adopting the constitution shown in Table 9.

In Table 9, an Al-PE multi-layer structure as a positive electrode current collector was obtained by vapor depositing an aluminum layer with a thickness of 6 μm on both sides of a polyethylene-based resin layer (a melting point of 120° C.) with a thickness of 20 μm.

A Cu-PE multi-layer structure as a negative electrode current collector was obtained by forming a Cu layer with a thickness of 6 μm through electroless plating on both sides of a polyethylene-based resin layer (a melting point of 120° C.) with a thickness of 20 μm.

In addition, 2500 manufactured by Celgard. K.K. (a melting point of 150° C.) was used for an olefin-based separator.

Next, ‘H/I’ in the binder signifies that SBR represented by the abbreviation H is used for the negative electrode side and PVDF (9300 manufactured by Kureha Corporation: a melting point of 170° C., a weight-average molecular weight of 100,000) represented by the abbreviation I is used for the positive electrode side. Positive electrodes of Comparative Examples 17 to 20 were formed by using not a thickening material but PVDF as a binder by 7 parts by weight. A forming method is described specifically. That is to say, NMP was added to PVDF by a proper amount, and thereto added were the conductive material and the positive electrode active material in this order while kneading, to thereby obtain a positive electrode paste. The obtained positive electrode paste was applied on both sides of the positive electrode current collector by a predetermined amount, and dried provisionally at 80° C. and thereafter dried regularly in vacuo to thereby obtain a positive electrode.

With regard to the lamination number, in the case where positive/negative was 9/10, the thickness of the positive electrode was 80 μm and the thickness of the negative electrode was 60 μm; in the case where positive/negative was 6/7, the thickness of the positive electrode was 120 μm and the thickness of the negative electrode was 90 μm (the total value of thicknesses on both sides of the current collector).

TABLE 9

| | | | Positive electrode | | | Negative electrode | |
|---|---|---|---|---|---|---|---|
| | | Positive | active material | | Negative | active material | |
| | | electrode | Application | | electrode | Application | |
| | | current | amount | Density | current | amount | |
| | | collector | mg/cm² | g/cm² | collector | mg/cm² | Density g/cm² |
| Examples | 34 | Al foil-PE multi-layer structure | 17 | 1.9 | Cu foil | 10 | 1.5 |
| | | (melting point of 120° C.) | | | | | |
| | 35 | As above | 25.5 | 1.9 | As above | 15 | 1.5 |
| | 36 | Al foil | 17 | 1.9 | Cu foil-PE multi-layer structure | 10 | 1.5 |
| | | | | | (melting point of 120° C.) | | |
| | 37 | As above | 25.5 | 1.9 | As above | 15 | 1.5 |
| | 38 | Al foil-PE multi-layer structure | 17 | 1.9 | Cu foil | 10 | 1.5 |
| | | (melting point of 120° C.) | | | | | |
| | 39 | As above | 25.5 | 1.9 | As above | 15 | 1.5 |
| | 40 | Al foil | 17 | 1.9 | Cu foil-PE multi-layer structure | 10 | 1.5 |
| | | | | | (melting point of 120° C.) | | |
| | 41 | As above | 25.5 | 1.9 | As above | 15 | 1.5 |
| Comparative Examples | 17 | Al foil-PE multi-layer structure | 17 | 1.9 | Cu foil | 10 | 1.5 |
| | | (melting point of 120° C.) | | | | | |
| | 18 | As above | 25.5 | 1.9 | As above | 15 | 1.5 |
| | 19 | Al foil | 17 | 1.9 | Cu foil-PE multi-layer structure | 10 | 1.5 |
| | | | | | (melting point of 120° C.) | | |
| | 20 | As above | 25.5 | 1.9 | As above | 15 | 1.5 |

| | | | | | | | Nail penetration test result | | | |
|---|---|---|---|---|---|---|---|---|---|---|
| | | | | | | | Maximum | | | |
| | | | | | | | end-point | | | |
| | | | Nonaqueous | | Lamination number | Battery capacity | temperature | | | |
| | | Separator | electrolyte | Binder | of positive/negative | Ah | ° C. | No smoking | Smoking | Ignition |
| Examples | 34 | olefin- | EC-DEC (1:2) | E | 9/10 | 4 | 120 | 5 | 0 | 0 |
| | | based | 1M LiPF6 | | | | | | | |
| | | | 1% VC | | | | | | | |
| | 35 | olefin- | As above | E | 6/7 | 4 | 180 | 5 | 0 | 0 |
| | | based | | | | | | | | |
| | 36 | olefin- | As above | E | 9/10 | 4 | 130 | 5 | 0 | 0 |
| | | based | | | | | | | | |
| | 37 | olefin- | As above | E | 6/7 | 4 | 190 | 5 | 0 | 0 |
| | | based | | | | | | | | |
| | 38 | olefin- | As above | G | 9/10 | 4 | 130 | 5 | 0 | 0 |
| | | based | | | | | | | | |
| | 39 | olefin- | As above | G | 6/7 | 4 | 190 | 5 | 0 | 0 |
| | | based | | | | | | | | |
| | 40 | olefin- | As above | G | 9/10 | 4 | 140 | 5 | 0 | 0 |
| | | based | | | | | | | | |
| | 41 | olefin- | As above | G | 6/7 | 4 | 200 | 5 | 0 | 0 |
| | | based | | | | | | | | |
| Comparative | 17 | olefin- | As above | H/I | 9/10 | 4 | 220 | 2 | 3 | 0 |
| Examples | | based | | | | | | | | |
| | 18 | olefin- | As above | H/I | 6/7 | 4 | 260 | 1 | 4 | 0 |
| | | based | | | | | | | | |
| | 19 | olefin- | As above | H/I | 9/10 | 4 | 240 | 2 | 3 | 0 |
| | | based | | | | | | | | |
| | 20 | olefin- | As above | H/I | 6/7 | 4 | 300 | 0 | 5 | 0 |
| | | based | | | | | | | | |

From Table 9, it is found that even though resin kinds of the resin layer and binder kinds composing the current collector are modified, the secondary battery with a high safety is obtained when a relation of the melting points of the resin layer and the binder is within a specific range.

The nonaqueous electrolyte secondary battery of the present invention can improve the safety since:
the melting point of the resin layer composing the current collector on the positive electrode and/or the negative electrode sides is within a specific range, and
the melting point of the binder composing the electrode formed on the current collector having the resin layer with the melting point within the specific range is within a specific range in relation to the melting point of the resin layer.

Also, an electrode for obtaining the nonaqueous electrolyte secondary battery capable of improving the safety can be provided.

Also, in the case where the active material is contained in the electrode in an amount of 18 to 42 mg/cm² for the positive electrode and in an amount of 11 to 24 mg/cm² for the negative electrode, the battery of the present invention can further improve the safety while securing a battery capacity.

In addition, in the case where the active material is contained in the electrode at a density of 1.6 to 2.2 g/cm³ for the positive electrode and at a density of 1.1 to 1.6 g/cm³ for the negative electrode, the battery of the present invention can further improve the safety while securing a battery capacity.

Also, even in the case where the abnormal heat generation is a heat generation of a higher temperature than the melting point of the resin layer, the nonaqueous electrolyte secondary battery with the improved safety can be provided.

In addition, the present invention can be provided the nonaqueous electrolyte secondary battery with the improved safety even in a comparatively high capacity of 4 Ah or more.

Also, in the case where the resin layer and the binder are selected from resins in a combination of a polypropylene-based resin and a polypropylene-based resin or a polyethylene-based resin and in a combination of a polyethylene-based resin and a polyethylene-based resin, the battery of the present invention can further improve the safety.

What is claimed is:

1. A nonaqueous electrolyte secondary battery comprising electrodes composed of a positive and negative electrodes containing an active material, and a separator between the positive electrode and the negative electrode; wherein
one of the positive electrode and the negative electrode contains a binder and is formed on a current collector;
the current collector has a structure composed of a resin layer so as to melt upon an abnormal heat generation and metal layers as an electric conductor formed on both sides of the resin layer;
the resin layer has a melting point of 120 to 250° C.; and
the binder has a melting point between 70° C. and a lower temperature than above mentioned melting point of the resin layer by 40° C.

2. The nonaqueous electrolyte secondary battery according to claim 1, wherein the resin layer has a melting point of 120 to 200° C.; and
the binder has a melting point between 70° C. and a lower temperature than above mentioned melting point of the resin layer by 40° C.

3. The nonaqueous electrolyte secondary battery according to claim 1, wherein the resin layer and the binder are selected from resins in a combination of a polypropylene-based resin and a polypropylene-based resin or a polyethylene-based resin and in a combination of a polyethylene-based resin and a polyethylene-based resin.

4. The nonaqueous electrolyte secondary battery according to claim 1, wherein the active material is contained in the electrode in an amount of 18 to 42 mg/cm² for the positive electrode and in an amount of 11 to 24 mg/cm² for the negative electrode.

5. The nonaqueous electrolyte secondary battery according to claim 1, wherein the active material is contained in the electrode at a density of 1.6 to 2.2 g/cm³ for the positive electrode and at a density of 1.1 to 1.6 g/cm³ for the negative electrode.

6. The nonaqueous electrolyte secondary battery according to claim 1, wherein the abnormal heat generation is a heat generation of a higher temperature than the melting point of the resin layer.

7. The nonaqueous electrolyte secondary battery according to claim 1, wherein the nonaqueous electrolyte secondary battery has capacity of 4 Ah or more.

8. An electrode for a positive electrode or a negative electrode of a nonaqueous electrolyte secondary battery, comprising electrodes composed of a positive electrode and a negative electrode, and a separator between the positive electrode and the negative electrode; wherein
one of the positive electrode and the negative electrode contains a binder and is formed on a current collector;
the current collector has a structure composed of a resin layer so as to melt upon an abnormal heat generation and metal layers as an electric conductor formed on both sides of the resin layer;
the resin layer has a melting point of 120 to 250° C.; and
the binder has a melting point between 70° C. and a lower temperature than above mentioned melting point of the resin layer by 40° C.
